(19) United States
(12) Patent Application Publication
(10) Pub. No.: US 2021/0080907 A1
(43) Pub. Date: Mar. 18, 2021

(54) REFLECTION MODE VOLUME HOLOGRAPHIC OPTICAL ELEMENTS (VHOES)

(71) Applicants: Arkady Bablumyan, San Diego, CA (US); Lloyd J. LaComb, JR., Tucson, AZ (US); Nasser N. Peyghambarian, Tucson, AZ (US)

(72) Inventors: Arkady Bablumyan, San Diego, CA (US); Lloyd J. LaComb, JR., Tucson, AZ (US); Nasser N. Peyghambarian, Tucson, AZ (US)

(21) Appl. No.: 17/102,513

(22) Filed: Nov. 24, 2020

Related U.S. Application Data
(63) Continuation-in-part of application No. 15/720,349, filed on Sep. 29, 2017, now Pat. No. 10,871,601.
(60) Provisional application No. 62/403,584, filed on Oct. 3, 2016.

(51) Int. Cl. G03H 1/02; G03H 1/04; G02B 5/32; G02B 27/42; G02B 27/00

(52) U.S. Cl. CPC G03H 1/0248; G03H 1/0402; G02B 5/32; G03H 2223/19; G02B 27/0056; G03H 2223/24; G03H 2001/0439; G02B 27/4211

(57) ABSTRACT

Reflection mode VHOEs are designed and fabricated for use in imaging and other applications that require high diffraction efficiency with minimal chromatic aberrations and astigmatism across the bandwidth. A single VHOE acts as a mirror to reflect light (0^{th} diffraction order) at the specified wavelength(s) and bandwidth with a principal ray at an angle equal to an angle of incidence of broadband light. A composite VHOE includes a complementary pair of input and output VHOEs each configured to diffract light into a non-zero N^{th} order. The input and output VHOEs are positioned in parallel to and offset from each other such that the filtered N^{th} order beam exits the composite lens on a path at the angle of incidence and parallel to the broadband light while suppressing the unwanted 0^{th} order beam. The composite lens improves suppression of unwanted wavelengths while still achieving minimal chromatic aberration.

### CROSS-REFERENCE TO RELATED APPLICATIONS

This application is a continuation-in-part of and claims priority to U.S. patent application Ser. No. 15/720,349 entitled “Volume Holographic Optical Elements for Imaging With Reduced Aberrations”, filed Sep. 29, 2017, which claims benefit of priority under 35 U.S.C. 119(e) to U.S. Provisional Application No. 62/403,584 entitled “Broadband High Resolution Diffraction Optics” and filed on Oct. 3, 2016, the entire contents of which are incorporated by reference.

### BACKGROUND OF THE INVENTION

### Field of the Invention

The invention relates to a volume holographic optical element WHOP suitable for imaging applications in one or more wavelength bands and the fabrication thereof. The invention recreates holographically, the properties of refractive or reflective optics to produce a lightweight, thin film, lens. The holographic optical elements can be thinner, lighter, and less expensive than the corresponding refractive or reflective optical elements that they replace. The holographic optical elements can he designed to minimize aberrations in the output wavefront while maintaining high diffraction efficiencies to improve the performance of the imaging system.

### Description of the Related Art

Holography is the science and practice of making holograms. Typically, a hologram is a recording of the interference pattern created by the interaction of two light fields (typically called the reference and object beams), rather than of an image formed by a lens. The hologram contains both the amplitude and relative phase of the light fields as opposed to a photograph that contains only the intensity of the recorded light field. The developed hologram works as a diffraction grating that when illuminated by the reference beam generates an output beam that contains the exact wavefront of the object beam. The object beam can be light from a physical object or a computer-generated scene. When the reference beam illuminates the hologram the diffracted light reconstructs a full 3D image of the scene with its full parallax. If the wavefront of the object beam is chosen to have a particular geometric property e.g., spherical or cylindrical shape then the hologram will work as a lens e.g., a spherical or cylindrical lens, thus allowing the hologram to function as an optical element that provides optical power for magnification (larger or smaller).

A Holographic Optical Element (HOE) is a thin film optical device that functions as traditional optical component. HOEs can operate in either transmission replacing and enhancing traditional refractive optics such as lenses, or in reflection replacing and enhancing traditional reflective optics such as mirrors, beam splitters and beam combiners. HOEs can also be designed to generate waveforms not available to traditional refractive and reflective optics including: multi-focus lenses, power mirrors with see-through functionality, etc. especially holographic lenses are widely used in the art and become particularly useful in the wavelength range where refractive optics becomes opaque. The examples of such applications are X-ray and deep UV contact-less photolithography.

The underlying physics of the diffraction of light from a hologram is different depending on the thickness of the recording media. A thin hologram is one where the thickness of the recording medium is much less than the spacing of the interference fringes that make up the holographic recording. In a thin hologram, light scatters into multiple orders where each order corresponds to a particular angle. A thick or volume hologram is one where the thickness of the recording medium is greater than the spacing of the fringes of the interference pattern. The recorded hologram is now a three dimensional structure and HOEs recorded in this fashion are often called Volume Holographic Optical Elements or VHOEs. In a thick hologram, light scatters into primarily one diffraction order. VHOEs can be fabricated using a wide variety of materials including: Dichromated gelatin, photopolymers, and photoemulsions. The scattering of light from VHOE is governed by the Bragg Equation

2\tilde{n}Λ sin(θ+ϕ)=λ (1)

where ñ is a positive integer and is used to enumerate the diffraction order, λ is the wavelength, Λ is the average grating period, θ is the angle between the incident beam and the normal and ϕ is the angle between the normal and the grating vector.
The diffraction efficiency of the TE mode of the diffraction grating is calculated [Blanche et al, Opt. Eng. 43(11) 2603-2612 (November 2004)] as

η_{TE}=sin²[πΔnd/(λ cos θ₁)] (2)

where η is the diffraction efficiency Δn is the change in refractive index of the VHOE material, d is the thickness of the VHOE, λ is the wavelength and θᵢ is the angle of incidence. The first order spectral and angular bandwidth (full width half maximum, FWHM) can be approximated by

Δλ_{FWHM}/λ≈(Λ/d)cot θᵢ (3)

and

Δθ_{FWHM}≈Λ/d (4)

where Λ is the average grating period of the VHOE. Similar equations can be derived for the TM mode.

VHOEs are fabricated by interfering the object and reference beams in a recording medium. The object beam contains the desired output waveform that will be created when the VHOE is illuminated by the reference beam. The VHOE can operate in transmission mode where the light enters on one side of the VHOE and exits on the other side with the desired wavefront. In reflection mode, the light enters on one side of the VHOE and exits on the same side.

When used in transmission mode, current embodiments of VHOEs suffer from either low diffraction efficiency (light within the desired bandwidth directed to the desired angle or angles divided by the total light in that bandwidth) or chromatic aberration (where a lens is either unable to bring all wavelengths to a focus in the same focal plane, and/or when wavelengths are focused at different positions in the focal plane) and astigmatism (where rays that propagate in two perpendicular planes have different foci).

Previous studies of Holographic Optical Elements [D. H. Close. “Holographic Optical Elements”, Optical Engineering, Vol 14, No 5 pp 409-419, 1975] concluded that the strong dependence of the HOE's imaging properties on the operating wavelength due to their diffractive nature makes it more difficult to design achromatic optical systems with HOE than conventional optics. This difficulty has resulted in HOE used only in quasi monochromatic or narrowband (Δλ<10 nm) applications.

For imaging applications, traditional refractive and reflective optical elements and their holographic replacements accept input light and relay that light to an image conjugate plane. In many imaging applications, a particular instantiation of a HOE called a zone plate is used for in-line focusing. [Zone Plates and Their Aberrations: M. Young, Electro-physics and Electronic Engineering, Rensselaer Polytechnic Institute, NY, OSA Vol. 62 No. 8, pages 972-976.]. The ideal zone plate can be considered as a hologram of coaxial collimated and spherical beams also called a Gabor plate. Such a holographic optical element works as an on-axis lens and provides diffraction-limited performance in the paraxial approximation in narrowband wavelength (Δλ≤10 nm) range. Other examples of the applications where the zone plates show superior performance compared to regular refractive optics are: image projection in the deep UV spectral range where regular optics become opaque or multi-focus lens made by stacking of zone plates in single film [Banyai, William Charles et al. “Composite holographic multifocal lens”, US 20010050751], wide field of view projection using segmented zone plates [Spitz, Eric, et al., “High-resolution, wide-field holographic lens”, U.S. Pat. No. 4,094,577, and Close D., “Extended-field holographic lens arrays”, U.S. Pat. No. 3,807,829]. However the biggest disadvantage of the zone plate is that the light is diffracted into multiple diffraction orders, which results in both low diffraction efficiency (DE <40%) in the desired diffraction order and low image contrast because of crosstalk (unwanted signal or noise introduced by one optical signal onto another optical signal) with unwanted diffraction orders.

Other known attempts to address the low diffraction efficiency in narrowband imaging applications have been explored including shaping the grooves of the zone plates (Fresnel lens, blazed diffraction structure, etc.,) allowing them to direct input light energy to only one diffraction order. However, these approaches significantly complicate the manufacturing process and makes fabrication of large HOEs problematic [D. H. Close, “Holograpihic Optical Elements”, Optical Engineering, Vol 14, No 5 pp 409-419, 1975].

Other authors [Pernick, Benjamin J., “In-line holographic lens arrangement”, U.S. Pat. No. 4,810,047] have suggested making an on-axis zone plate with suppressed strait light of 0-th diffraction order by combining it with a polarization rotator and polarization filter, and using the fact that polarization rotation of diffracted focusing beam is different than that of collimated 0-th order beam. However, such a structure further decreases the amount of light in the focusing beam due to absorption of the polarizers and the angular dependence of the polarization rotation results in non-uniformity in the focusing beam passing through the polarization filter.

Other attempts [D. L. Dickensheets, “Imaging performance of off-axis planar diffractive lenses”, Vol. 13, No. 9/September 1996/J. Opt. Soc. Am. A, pp 1849-1858] to improve the diffraction efficiency in transmission VHOE systems have explored off-axis focusing. Single order volumetric holograms working in the Bragg regime have been fabricated which resolve the issues of low contrast due to the cross-talk between multiple diffraction orders seen in Gabor zone plates. To operate in the Bragg regime, off-axis angles should be larger than θₘᵢₙ derived from the following formula [Coupled Wave Theory for Thick Hologram Gratings, Herwig Kogelnik, Bell System Technical Journal, Volume 48, Issue 9, pages 2909-2947, November 1969]

$$cos {θ}_{min} = \frac{λ}{2 d Δ n} \qquad ( 5 )$$

This condition corresponds to 100% diffraction of the input beam to the first diffraction order. The high diffraction angles introduce significant astigmatism due to the asymmetry in the diffraction pattern. The large diffraction angles also increase the chromatic aberration according to the Bragg equation. In addition to introducing astigmatism and chromatic aberration, the off-axis VHOE requires a more complicated design architecture to accommodate the off-axis constraints and cannot be used as a direct replacement for an on-axis refractive optical element.

While numerous attempts have been made to fabricate a volume holographic optical element capable of providing on-axis imaging, there are no reports of a VHOE capable of working in on-axis geometry while providing high diffraction efficiency (>75% and preferably greater than 95%) for desired diffraction order and suppressing the unwanted diffraction orders (<0.1%) and reducing the chromatic aberrations and astigmatism. Current attempts to expand reflection VHOE to broadband operation (>10 nm) show significant chromatic aberration and astigmatism making them impractical for imaging applications.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

This invention describes the design and fabrication of single element and composite reflection mode VHOEs that provide high diffraction efficiency and reduce chromatic aberrations and astigmatism in imaging and other applications. These VHOE can be used for imaging at one or more wavelengths in applications such as telescopes, image projection, and other optical systems. The lens can provide optical power (magnification) within the bandwidth centered relative to several wavelengths to either focus or collimate light and is transparent for the rest of the image spectrum. The size of each bandwidth can be controlled by proper choice of VHOE parameters in order to keep the lens aberrations within acceptable range. Each bandwidth may be narrowband (<10 nm) or broadband (>10 nm). These VHOEs can be used in a significant number of applications which employ broadband sources such as light emitting diodes (LED), organic light emitting diodes (OLED), supercontinuum sources (SLD/SLED) and silicon optical amplifiers (SOA) without the need for safety and regulatory issues associated with laser sources. For the invention to achieve high diffraction efficiency and to correct for inherent aberrations caused by large diffraction angles and broadband sources, the traditional VHOE designs must be modified.

In a single element configuration, the VHOE is configured to act as a mirror at the specified wavelength(s) and bandwidth(s) and to form an image. The reflection from the “mirror” is equivalent to the 0^{th} order diffraction in which the VHOE is designed to reflect light (or diffract light in the 0^{th} order) in a principal ray at an angle equal to the angle of incidence according to Snell's Law. At this condition, all of the desired wavelengths are reflected at the same angle. No angular dispersion occurs and chromatic aberration is minimized.

A method of fabricating a single element reflection mode lens comprises interfering a collimated reference beam and a non-collimated object beam configured with optical power at equal but opposite angles with respect to a surface normal of a recording media on opposite sides of the recording media to record a diffraction pattern on the recording media with fringes of the diffraction pattern substantially parallel to a top surface of the recording media to form a reflection mode VHOE. The diffraction pattern is configured to reflect light achromatically at a known wavelength and bandwidth and transmit other wavelengths to form an output beam from the reflected light with a principal ray at an angle equal to an angle of incidence of broadband light and to magnify through diffraction the output beam to form an image. The bandwidth of the reflection VHOE can be controlled by proper choice of hologram thickness and index modulation. The equal but opposite angles for recording the diffraction pattern are equal to the angle of incidence and the reflected angle.

In a composite configuration, the input and output VHOEs are configured to diffract light into an N^{th} order where N is not zero. The input and output VHOEs are positioned in parallel to and offset from each other such that the filtered N^{th} order beam exits the composite lens on a path at the angle of incidence and parallel to the broadband light and the unwanted 0^{th} order beam is discarded at each VHOE. The output VHOE compensates for and cancels the angular dispersion induced by the input VHOE. The composite lens improves suppression of unwanted wavelengths while achieving minimal chromatic aberration.

Various embodiment of the composite lens are possible. In one embodiment, parallel light is incident on the input VHOE and is focused by the second VHOE. In another embodiment, light from a point source at the focal distance of the input VHOE is incident on the input VHOE and exits the composite lens at the focal distance of the output VHOE where the focal distances of the input VHOE and output VERDE need not be the same distance. In a third embodiment, broadband parallel light enters and exits the composite lens but is filtered into to one or more narrow wavelength ranges.

A method of fabricating a composite lens comprises fabricating two complementary VHOE elements. The input VHOE (also called VHOE1) is fabricated by interfering a collimated reference beam and (depending on the application) a non-collimated object beam (FIGS. 13a and 13b) configured with optical power or a collimated (FIG. 13c) at different angles with respect to a surface normal of a recording media on opposite sides of the recording media to record a diffraction pattern on the recording media with fringes of the diffraction pattern substantially parallel to a top surface of the recording media to form a reflection mode VHOE. The reference beam for in the input VHOE is configured at the angle of incidence relative to the surface normal of the composite lens of broadband light and the object beam's primary ray is configured at the selected diffraction angle relative to the surface normal. This configuration will introduce chromatic and angular dispersion of the output beam according to equations 3 and 4. The bandwidth of these dispersion artifacts can be controlled by proper choice of hologram thickness and index modulation as shown in equations 3 and 4.

The output VHOE (also called VHOE2) is fabricated interfering a collimated reference beam and (depending on the application) a non-collimated object beam (FIGS. 13a and 13b) configured with optical power or a collimated (FIG. 13c) at complementary angles with respect to a surface normal used in the fabrication of the input VHOE of a recording media on opposite sides of the recording media to record a diffraction pattern on the recording media with fringes of the diffraction pattern substantially parallel to a top surface of the recording media to form a reflection mode VHOE. The reference beam for in the output VHOE is configured at the selected diffraction angle relative to the surface normal output VHOE and the object beam's primary ray is configured at the angle of incidence of the broadband light on the composite lens relative to the surface normal. This configuration will compensate for the chromatic and angular dispersion introduced by the input VHOE as long as the two VHOEs have the same hologram thickness and index modulation.

For a color system, multiple (e.g., three) color holograms can be printed simultaneously on a common recording media at different wavelengths (e.g., RGB) with a common focal point while the unwanted portions of the while light spectrum pass through the HOE undiffracted since they do not satisfy the Bragg condition.

The reflective mode VHOEs may also be configured for applications other than traditional imaging such as multi-focus lenses and lens arrays in which the object beam for recording the diffraction grating is selected to perform an optical function such as multiplexing in the axial or lateral dimensions. In this case, the diffraction grating would be configured to more generally shape the direction and wavefront of the output beam as opposed to the specific application of forming an image. The improved performance of the VHOEs in the form of higher diffraction efficiency and lower chromatic aberrations and astigmatism over the bandwidth would have the beneficial effect in these other applications.

These and other features and advantages of the invention will be apparent to those skilled in the art from the following detailed description of preferred embodiments, taken together with the accompanying drawings, in which:

### BRIEF DESCRIPTION OF THE DRAWINGS

FIGS. 1 and 2 are perspective and detailed illustrations of an embodiment of a transmission mode composite lens including first and second VHOEs;

FIGS. 3a-3d are illustrations of an embodiment of a method of fabricating the transmission mode composite lens;

FIG. 4 is a diagram of an embodiment of the wavefront direction and interference pattern for plane grating object and reference beams for a transmission mode VHOE;

FIGS. 5a and 5b are diagrams of an embodiment of a full color transmission mode composite lens and the diffraction geometry of the composite lens for minimizing crosstalk between color channels;

FIG. 6 is a diagram of a transmission mode composite lens doublet;

FIG. 7 is a perspective view of an embodiment of a broadband reflection mode VHOE;

FIGS. 8 and 9 are diagrams of a method of fabricating the reflection mode VHOE, the wavefront direction and interference pattern for plane grating object and reference beams for the reflection mode VHOE and the interference pattern of the VHOE;

FIG. 10 is a diagram of an embodiment of a full color reflective mode VHOE;

FIG. 11 is a diagram of an embodiment of a system implementation of the reflective mode VHOE in which an object is overlaid on a real scene;

FIG. 12 is a diagram of a narrowband reflection VHOE composite lens;

FIGS. 13a through 13c are embodiments of plano-convex, biconvex and filter implementations of a broadband reflection VHOE composite lens; and

FIGS. 14a and 14b are diagrams of an embodiment for fabricating the input reflection mode VHOE, and output reflection mode VHOE of a complementary pair.

### DETAILED DESCRIPTION OF THE INVENTION

This invention describes the design and fabrication of two types of VHOEs (transmission and reflection) that can be used in traditional imaging and other applications. These VHOE provide high diffraction efficiency with minimal aberrations and can be used for imaging at one or more wavelengths in applications such as telescopes, image projection, and other optical systems. The VHOE lenses provide optical power (magnification) within the bandwidth centered relative to several wavelengths and is transparent for the rest of the image spectrum. The size of each bandwidth can be controlled by proper choice of VHOE parameters in order to keep the lens aberrations within acceptable range. Each bandwidth may be narrowband (<10 nm) or broadband (>10 nm). These concepts are further extended to create VHOEs that operate with high diffraction efficiency at multiple wavelengths (colors) with each wavelength having a separate bandwidth. These VHOEs can be used in a significant number of applications which employ broadband sources such as light emitting diodes (LED), organic light emitting diodes (OLED), supercontinuum sources (SLD/SLED) and silicon optical amplifiers (SOA) without the need for safety and regulatory issues associated with laser sources.

To achieve high diffraction efficiency and to correct for inherent aberrations introduced in imaging applications with broadband sources, the traditional VHOE designs must be modified to achieve high-resolution imaging and improved performance in other non-imaging applications.

As previously described, in transmission mode traditional on-axis VHOE designs employ a single zone plate or a Gabor pate that is fabricated using coaxial collimated and spherical beams. The on-axis VHOE exhibits low diffraction efficiency (≤40%) into the focal spot and deliver low image contrast because of crosstalk with unwanted diffraction orders. A traditional off-axis VHOE design operates in the Bragg regime to improve DE (>90%) but introduces high levels of chromatic aberration and astigmatism.

In the present invention, two VHOEs are designed and fabricated in such a way as to provide high diffraction efficiency and introduce compensating adjustments that minimize the astigmatism and chromatic aberrations. Two VHOEs that form a “composite lens” (CL) are required to provide an on-axis imaging system to magnify light to form an image and reduce the chromatic aberrations and astigmatism across the bandwidth while maintaining high diffraction efficiency (DE) and low noise.

In reflection mode, the traditional VHOE designs provide high diffraction efficiency but introduce significant aberrations when used in imaging applications due to Fresnel refraction.

In the present invention, a single reflective VHOE is configured to act as a mirror at the specified wavelength and bandwidth (i.e., reflects the specified wavelength and bandwidth at an angle equal to the angle of incidence (0^{th} diffraction order)) and to magnify light to form an image and, consequently, has minimal level of astigmatism and chromatic aberration. This is accomplished by fabricating the single VHOE with recording and object beams at equal and opposite angles to the surface normal so that the fringes of the diffraction pattern are parallel to the surface of the recording media and by using a spherical object beam to record the diffraction pattern to magnify the light. The equal recording angles are also equal to the angle of incidence/angle of reflection.

In a composite configuration, a complementary pair of input and output reflection mode VHOEs are configured to diffract light into an N^{th} order where N is not zero. The input and output VHOEs are positioned in parallel to and offset from each other such that the N^{th} order beam exits the composite lens on a path at the angle of incidence and parallel to the broadband light while the unwanted 0^{th} order beam is discarded. The composite lens improves suppression of unwanted wavelengths while achieving minimal chromatic aberration. The composite lens may be configured as a filter only or a bi-convex or planoconvex lens equivalent. The suppression of unwanted wavelengths and producing a beam with minimal chromatic aberration is accomplished by fabricating two complementary VHOE with the same thickness and index modulation with the interference beams at complementary angles. The input VHOE is fabricated with the reference beam at the angle of incidence and the object beam at the selected internal diffraction angle. The output VHOE is fabricated with the reference beam at the selected internal diffraction angle and the object beam at the angle of incidence. When the two lenses are parallel to each other, this configuration ensures that any angular and chromatic dispersion introduced by the input VHOE is compensated by the output VHOE.

The transmissive composite lens and the reflective VHOE lens, as all optical lenses, perform different but related transforms on the input light depending on the direction light traverses the lens. For the transmission lens, collimated light entering from the same side as the reference beam used for recording is brought to a focus. Conversely, input light diverging from the focal point will pass through the composite lens and be collimated. The same symmetry is present in the reflective lens where collimated light reflecting from the surface is brought to a focus and light diverging from the focal point is collimated. In either case, a diffraction pattern is recorded to include optical power to magnify light (larger or smaller) to focus or collimate the output beam to form the image.

### Transmission-Mode Composite Lens

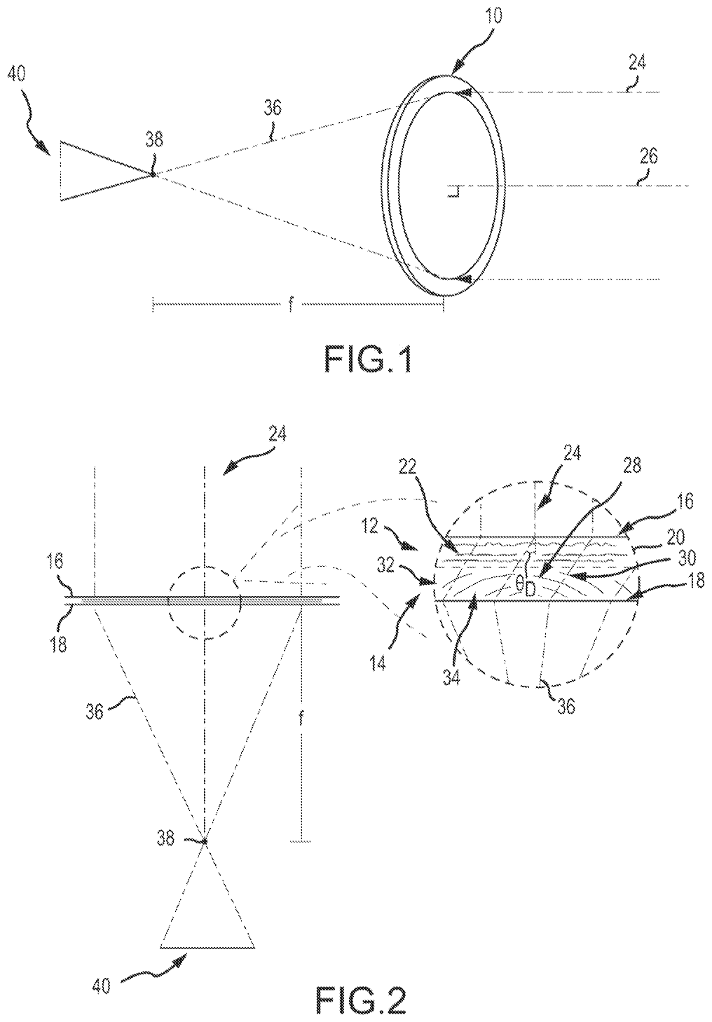

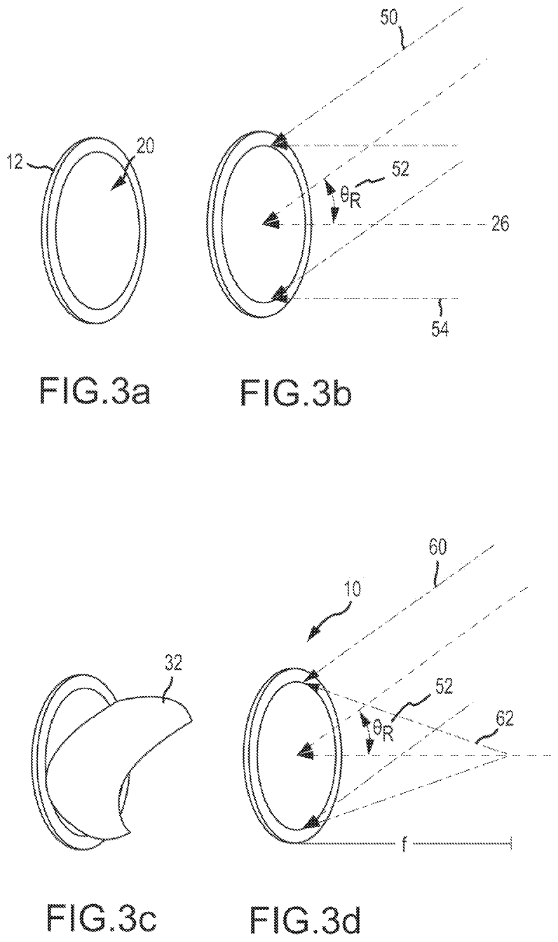

As shown in FIGS. 1 and 2, in an embodiment, an on-axis single bandwidth transmission mode composite lens 10 comprises first and second transmission mode Volume Holographic Optical Elements VHOE1 12 and VHOE2 14 sandwiched between glass substrates 16 and 18. VHOE1 12 comprises a holographic recording media 20 and a diffraction pattern 22 recorded on the recording media. Diffraction pattern 22 is configured to receive broadband light 24 on-axis along a surface normal 26 to VHOE1 and deflect through transmission light at a known wavelength and bandwidth at a known angle θ_{D} 28 to the surface normal 26 to form an off-axis output beam 30. VHOE2 14 comprises a holographic recording media 32 and a diffraction pattern 34 recorded on recording media 32. Diffraction pattern 34 is configured to accept the off-axis output beam 30 at the known wavelength and the known angle and to form and focus through diffraction an on-axis output beam 36 at the known wavelength at a focal point 38 to form an image 40 at a conjugate plane.

The two VHOE are configured to introduce compensating adjustments that minimize the chromatic aberrations introduced by the bandwidth of the input light and astigmatism. VHOE1 compensates for aberrations induced by VHOE2. The pair of VHOEs is required to provide an on-axis imaging system to focus light to form an image and reduce the chromatic aberrations across the bandwidth and reduce the astigmatism while maintaining high diffraction efficiency (DE) and low noise.

This on-axis geometry achieves diffraction efficiencies of >75% can be achieved over the lens' bandwidth and suppresses unwanted diffraction orders to <1%. The remaining light in the bandwidth is either scattered or absorbed. The light outside of the bandwidth passes through the VHOE. In many cases, the DE >95% over the bandwidth can be achieved and unwanted diffraction orders can be suppressed to <0.1%. The lens' bandwidth can be increased to greater than 10 nm depending on the requirements of the resolution of the VHOE by varying the incidence angles of the reference beam and choosing the holograms thickness and index modulation. Furthermore, the on-axis geometry minimizes chromatic aberrations and astigmatism over the bandwidth.

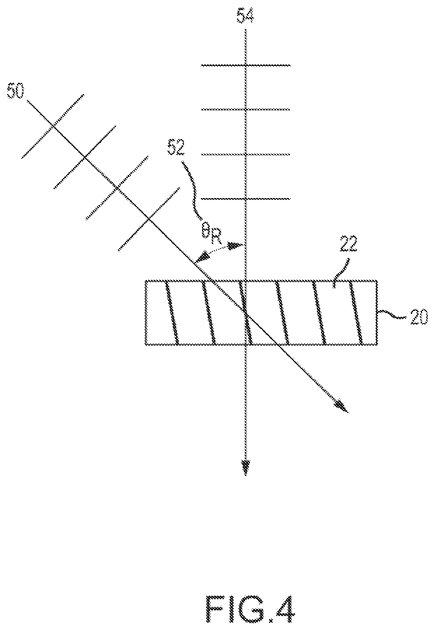

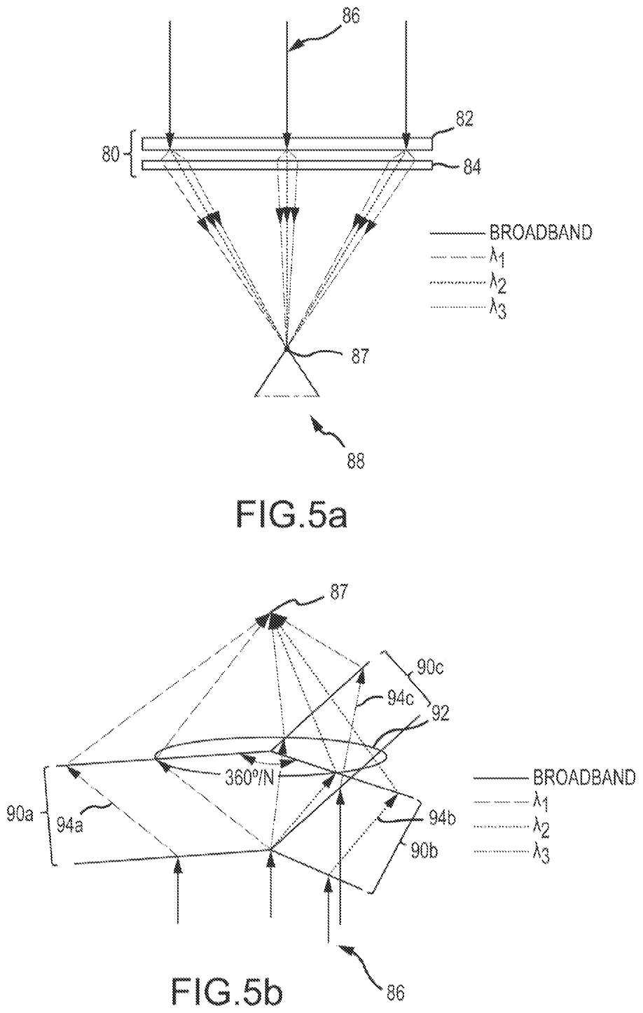

As shown in FIGS. 3a-3d and 4, in an embodiment, on-axis single bandwidth transmission mode composite lens 10 is fabricated by applying holographic recording media 20 to glass substrate 12. A collimated reference beam 50 at a recording angle θ_{R} 52 to the surface normal 26 is interfered with a collimated object beam 54 parallel to surface normal 26 to create an interference pattern that is recorded as diffraction pattern 22 (See FIG. 2) in recording media 20 to form VHOE1. Narrowband sources such as lasers at the known wavelength are used to provide the reference and object beams. Recording angle 52 determines the known angle at which diffraction pattern 22 will deflect input light. The VHOE1 hologram is developed according to the usual development procedure for the particular holographic media. The holographic media used in creating VHOE1 may be covered with a thin (≤100 micron) transparent layer if needed to ensure chemical and or mechanical stability during the exposure and processing of VHOE2.

VHOE2 is fabricated by applying a holographic recording media 32 (which can be the same type of media used in VHOE1 or a different media) to the surface of VHOE1. Diffraction pattern 34 (shown in FIG. 2) is recorded using a reference beam 60 having the same properties (same angle, wavelength, beam properties) as used in recording VHOE1 and an object beam 62 that is a diverging waveform with the desired focal length. Reference beam 60 is suitably reference beam 54. VHOE2 accepts light at the known angle from VHOE1 and focuses the light to form the image. The VHOE2 hologram is developed according to the usual development procedure for the particular holographic media. The holographic media used in creating VHOE2 may be covered with a thin transparent layer if needed to ensure chemical and or mechanical stability during use.

When these two VHOEs are used in combination, they function as an on-axis lens as shown for a single λ. Equation 6 [D. H. Close, “Holographic Optical Elements”, Optical Engineering, Vol 14, No 5 pp 409-419, 1975] the shows relationship between the principal input angle 24 (θ₁ ) and output angle (θ₂) and the wavelength of the CL.

$$d ( sin {θ}_{1} + sin {θ}_{2} ) = \frac{λ}{n} \qquad ( 6 )$$

Large input or diffraction angles introduce significant chromatic aberration. For the on-axis transmission CL, θ₁=0 for the collimated input beam and principal ray θ₂ of the output beam is also zero. θ₂ for the marginal rays 36 are a function of the f-number of the system. The chromatic aberrations for the VHOE would be the same as for the zone plate but with much higher DE and much lower noise. The on-axis geometry of this composite lens (CL) will have minimal chromatic aberration and negligible astigmatism since it minimizes the diffraction angles, which results in minimal dispersion.

Decreasing astigmatism further is possible by minimizing the distance between HOE1 and HOE2 to less than 100 microns by shortening the path of the image that propagates in the off-axis geometry. The aberrations in the CL system can be further minimized by placing VHOE1 and VHOE2 in contact with one another on the surface of a glass/plastic substrate.

The resolution of transmission mode CL 10 can be estimated by noting that the diffraction pattern of CL is similar to that of the hologram recorded using coaxial planar and spherical beams [Zone Plates and Their Aberrations: M. Young, Electro-physics and Electronic Engineering, Rensselaer Polytechnic Institute, NY, OSA Vol. 62 No. 8, pages 972-976.] that represents a zone plate. Thus, without sacrificing accuracy, we can apply the formulism of a Zone Plate to derive CL parameters.

According to [Young], chromatic aberration will not be noticeable if the radius r of the imaging lens is equal to or less than:

$${r}^{2} = \frac{f {λ}^{2}}{Δ λ} \qquad ( 7 )$$

where f is focal length, λ is the central design wavelength, and Δλ is interpreted as FWHM (full width half maximum) of the illumination source.

Combing Eq. 7 with Rayleigh resolution criteria:

$$Δ l = 1.22 f \frac{λ}{r} \qquad ( 8 )$$

provides an estimate of the maximum. spectral width of image beam Δλ to keep resolution of such a lens better than Δl. The spectral width of the image can be controlled by the bandwidth of the HOEs, which obeys equation 9 [Fabrication of Diffractive Optical Elements. Springer, E. Di Fabrizio, L. Grella, M. Baciocchi, M. Gentili, p, 149-160. 1997.],

$$\frac{Δ {λ}_{FWHM}}{λ} ∼ \frac{Λ}{d} cot ( θ ) \qquad ( 9 )$$

where Λ is the average period of the holographic grating, d is the film thickness, and θ is the Bragg angle. By choosing proper grating parameters, one can fix the resolution of CL better than Δλ of Eq. 9.

Although the diffractive properties are similar, transmission mode CL 10 has four significant advantages over that of a single element narrow band Zone Plate:
1. The diffraction efficiency can be much higher; >75% or even >90% vs. 25-30% for zone plate.
2. The transmission bandwidth of transmission mode CL 10 can be controlled by the designer to achieve both high resolution (diffraction limited focal spot) AND minimize the aberrations to an acceptable ranges required by the imaging application by adjusting the thickness and refractive index of the VHOE. For zone plates, the aberrations cannot be adjusted.
3. The CL suppresses all unwanted diffraction orders below 1% (0.1% is typical) and consequently provides much higher contrast in imaging applications.
4. As we will describe below, CL VHOE can combine multiple wavelength bands in single VHOE film, which makes the CL suitable for broadband imaging.

### Multi-Wavelength Transmission Mode Composite Lens

The concepts used to minimize aberrations in single wavelength CL can be expanded to VHOEs operating at multiple wavelengths to design and fabricate a CL that can be used in multi-wavelength or “color” applications. For most visible commercial applications, the imaging sources comprise three sources emitting at different wavelengths roughly corresponding to the tri-stimulus values of the human eye. The devices typically emit at the red, green, and blue (RGB) wavelengths in the visible spectrum. For applications in the infrared (IR) or ultraviolet (UV) multiple wavelengths will be selected depending on the sources and detectors available.

For multi-color transmission and reflection applications, the traditional fabrication technique is to fabricate and combine multiple holograms, one of each color, or to simultaneously record the holograms for each color in the recording media. Both the combination and simultaneous recording techniques have been unsuccessful due to the crosstalk that occurs when multiplexing multiple holograms in a single film layer or layer stack. The crosstalk reduces the contrast of the image because light at one wavelength is scattered by the diffraction grating recorded to diffract another wavelength.

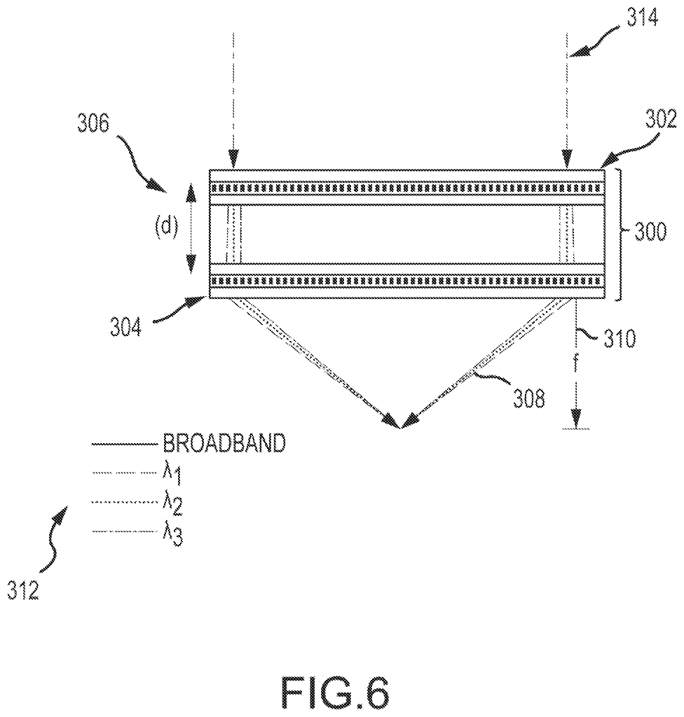

As shown in FIGS. 5a and 5b, a multi-wavelength transmission mode CL 80 is fabricated using techniques to simultaneously record a hologram associated with each of the wavelengths during a single exposure as a diffraction pattern on a recording media. For example, for RGB illumination, 3 pairs of reference and object beams simultaneously form 3 interference patterns that are superimposed and recorded to form the diffraction pattern. This design will enable the CL 80 to combine multiple wavelengths in a way that can achieve the resolution equivalent to the single bandwidth lens described above for each wavelength. For both VHOE1 82 and VHOE2 84, the multiple holograms can be combined in a single film fabrication using a single multi-wavelength exposure. The fabrication combines the wavelengths from separate lasers, resulting in a multi-wavelength hologram. VHOE1 and VHOE2 contribute to function as a three-color lens to spectrally filter on-axis broadband light 86 and focus the light at a focal point 87 to form a three-color image 88 at an image conjugate plane of the CL.

The present invention overcomes the crosstalk problem by designing the diffraction gratings for each wavelength to diffract the light at a different angle relative to the surface normal. As shown in FIG. 5b, planes 90a, 90b and 90c for each wavelength are rotated relative to each other at 360°/N where N is the number of wavelengths and the circle 92 is in the plane of the recording media. The process can also compensate for any decrease in DE by increasing Δn and/or film thickness to bring DE for each channel to its first maximum in accordance with Eq. 5. FIG. 5b shows the diffraction geometry for each wavelength from the input of the multicolored beams 86 to the angle of incidence of the CL optical axis. The collimated white light illuminating VHOE1 diffracts the three exposure wavelengths onto vectors 94a, 94b and 94c that lay in planes 90a, 90b and 90c, which are separated by 120°. As a result, there is no crosstalk (unwanted signal or noise introduced by one wavelength in the signal of another wavelength) between them. These wavelengths are then focused by VHOE2 to the designed focal distance. VHOE2 is designed and fabricated to accept each of the wavelengths at the known angles and bring them to a common focal point. Such a design combines several independant channels with negligible crosstalk, and independently controls the bandwidths for each λ. These factors will allow for fabrication of a visible CL with any predetermined resolution and color mixing for white light image projection systems. For applications where a larger wavelength range is needed, additional λ bandwidths can be easily added to the VHOE1 and VHOE2 to increase or decrease the overall spectral coverage or shift the center wavelength toward the IR or UV without affecting resolution.

The fabrication for the multi-wavelength CL systems follows the same sequence of operations as described above but with the reference beam used to fabricated VHOE1 and VHOE2 rotated about the surface normal by 360°/N (where N is the number of wavelengths). The N object beams for VHOE1 and VHOE2 are all co-axial and parallel to the surface normal.

### Multi-Wavelength Achromatic Doublet

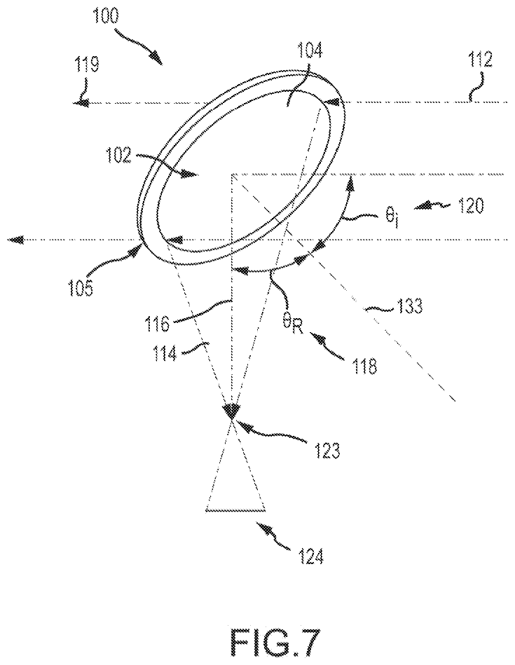

As shown in FIG. 6, two transmission mode composite lenses 302 and 304 can be combined into an achromatic doublet 300 to further reduce the chromatic aberration across a larger range of wavelengths 312 of broadband light 314. The doublet 300 may exhibit achromatic behavior over a wavelength range of ˜100 nm. The two CLs 302 and 304 are fabricated using the same processes described above.

Using a well-known formula for combined focal length f of two lenses with focal length f₁ and f₂,

$$\frac{1}{f} = \frac{1}{{f}_{1}} + \frac{1}{{f}_{2}} - \frac{d}{{f}_{1} {f}_{2}} , \qquad ( 10 )$$

and noting that the focal length of the VHOE is inversely proportional to wavelength λ, the separation d 306 between the CLs can be determined that corresponds to their achromatic performance over a wavelength range between λ₁ and λ₂ by requiring same combined focal length f 310 at the two extreme wavelengths λ₁ and λ₂.

Straight-forward calculation shows that a combination of two CL 302 and 304 with the same focal length f₁=f₂ separated at the distance d=0.67 f, an output beam 308 becomes achromatized to the first order. This technique can be used to extend the range of achromatization to 100 nm thus covering a much wider spectral range than each CL can on its own [Spectral Diffraction Efficiency Characterization of Broadband Diffractive Optical Elements Junoh Choi, Alvaro A. Cruz-Cabrera, Anthony Tanbakuchi, Sandia National Laboratories, March/2013] producing an achromatic holographic lens.

### Reflection Mode Lens

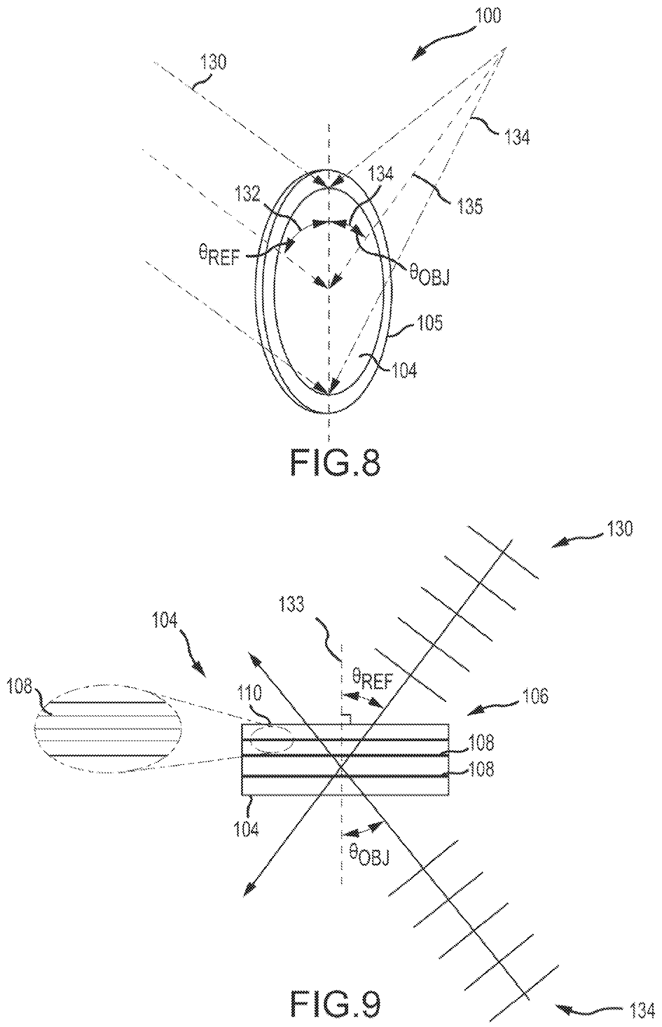

As shown in FIGS. 7-9, in an embodiment, an off-axis single bandwidth reflection mode lens 100 comprises a reflection mode volume holographic optical element (VHOE) 102. VHOE 102 comprises a recording media 104 applied to a glass substrate 105 and a diffraction pattern 106 recorded on the recording media with fringes 108 of the diffraction pattern substantially parallel to a top surface 110 of the recording media. Diffraction pattern 106 is configured to receive broadband light 112 and achromatically reflect light at a known wavelength and bandwidth and transmit other wavelengths to form an output beam 114 with a principal ray 116 at an angle θ_{R} 118 equal to an angle of incidence θᵢ 120 of broadband light 112 and to focus through diffraction the output beam 114 at a focal point 123 to form an image 124 at a conjugate plane.

Diffraction fringes parallel to the surface of the recording media acts as a bandpass filter centered at the known wavelength that reflects the wanted wavelengths in the bandwidth like a mirror and passes unwanted wavelengths 119 outside the defined bandwidth. The diffraction pattern 106 and fringes 108 include in the design a first component that is parallel to the surface to provide the achromatic reflection over the specified bandwidth and a second compute that is not parallel to the surface to provide the optical power or magnification that provides the focusing. The power of the lens or “f-number” determine how much deviation there is in the fringes from parallel. The stronger the lens the more the deviation.

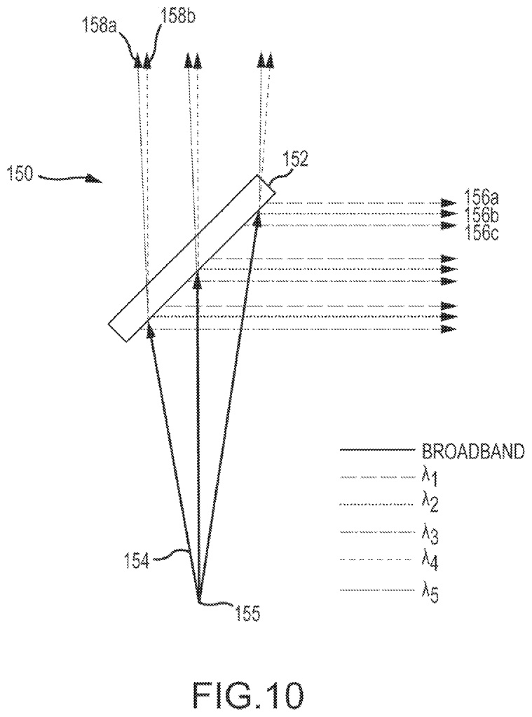

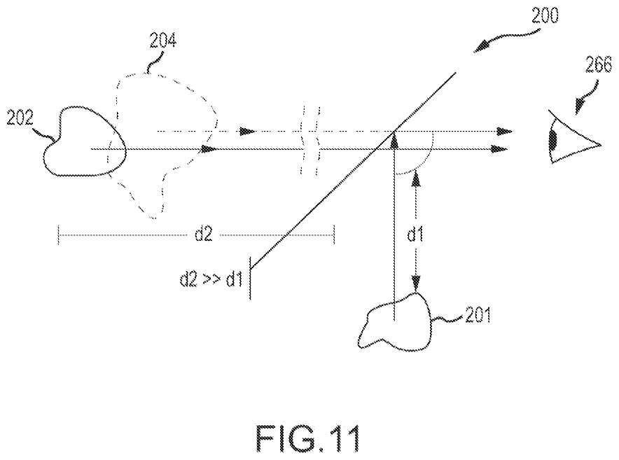

As shown in FIGS. 8 and 9, in an embodiment, off-axis single bandwidth reflection mode lens 100 is fabricated by applying the holographic media 104 to the glass substrate 105. A collimated reference beam 130 at an angle of incidence θ_{REF} 132 (between 0 and 90 degrees) from a surface normal 133 of the holographic media is interfered with a spherical object beam 134 having a principle ray 135 at an angle of incidence Row 136 to the surface normal from the opposite side of the recording media. The angles of incidence of the reference and object beams θ_{REF} 132 and θ_{OBJ} 134 being equal and opposite with the magnitude of the angles of incidence for recording being equal to the angle of incidence θᵢ 120 of the readout beam e.g. broadband light 112. The reflective VHOE hologram is developed according to the usual development procedure for the particular holographic media. The holographic media used in creating VHOE may be covered with a thin (≤100 micron) transparent layer if needed to ensure chemical and or mechanical stability of the reflective lens.

The equal angular illumination during the holographic recording creates a VHOE 104 with diffraction fringes 108 substantially parallel to the surface of the holographic film. This parallelism is modified to some extent by the optical power induced by the focusing object beam. The amount of deviation from parallel is determined by the power or f-number of the lens. This holographic fringe pattern acts as a high diffraction efficiency (DE >95%) mirror at the design wavelength and bandwidth. The reflective nature of the diffraction ensures the system has a minimal level of chromatic aberration when used for imaging. Chromatic aberration for such a HOE is minimal also because of the narrowband nature of reflection volumetric holograms and their bandwidth can be controlled by proper choice of hologram thickness and index modulation [Coupled Wave Theory for Thick Hologram Gratings, Herwig Kogelnik, Bell System Technical Journal, Volume 48, Issue 9, pages 2909-2947, November 1969]. Recording and reconstruction geometry for such a VHOE is shown in FIG. 9.

The reflection lens 100 as designed and fabricated as described above provides distortion-free see-through functionality where light can pass from the backside of the VHOE since light is traveling at angles that do not satisfy the Bragg equation and are not diffracted. This functionality is combined with a VHOE that provides optical power to create an image combiner with capabilities can't be achieved using standard refractive or reflective optics. Other embodiments of image combiners use semitransparent metallic coatings to integrate the pass through light and the reflected light but these embodiments cannot provide image magnification or minification without introducing considerable distortion by adding a curved reflecting surface.

While there are significant similarities between the function of reflection and transmission VHOEs, reflection VHOEs have two advantages:
Reflection VHOEs can be fabricated with a single layer element vs. the two adjacent VHOEs required for transmission composite lenses.
The reflection lens has distortion-free see-through functionality where light can pass from the backside of the HOE thorough the HOE since light is traveling at angles that do not satisfy the Bragg equation and are not diffracted. This functionality can be combined with an HOE that provides optical power to create an image combiner with capabilities can't be achieved using standard refractive or reflective optics.

### Multi-Wavelength Reflection Mode Lens

The reflective lens can be extended to multiple wavelength system by using techniques to simultaneously record the holograms associated with each of the wavelengths during a single exposure as a diffraction pattern on a single recording media. This design will enable the reflective VHOE to combine multiple wavelengths in a way that can achieve the resolution equivalent to the single bandwidth lens described above. The design and fabrication process can also compensate for any decrease in DE by increasing An and/or film thickness.

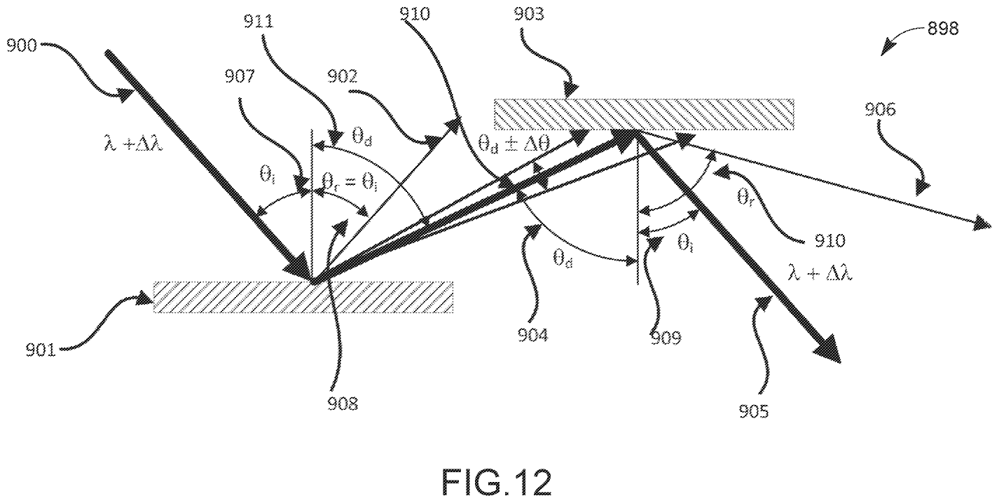

As shown in FIG. 10, in an embodiment, a multi-wavelength reflection mode lens 150 comprises a plurality of diffraction gratings recorded on a holographic recording media 152 at each of the wavelengths. Divergent broadband light 154 is reflected from the VHOE at the angle of incidence for each of the wavelengths and bandwidths 156a, 156b and 156c and the single point source is projected to infinity. Light 158a and 158b at unwanted wavelengths is transmitted through the VHOE. Equivalently collimated broadband light is reflected off of the VHOE and brought to a common focus.

As described, the single element reflective lens is designed to maximize DE in the 0^{th} order to reflect a band of light around a center frequency at the angle of incidence of the broadband light and suppress light in all other diffraction orders. The reflection is specular, all wavelengths in the band are reflected at the same angle. The VHOE does not induce any angular dispersion, hence the axial chromatic aberration is minimized. The lens acts as a filter to remove via transmission the unwanted wavelengths outside the band. However, the filtering of light is not perfect. Light outside the band of interest still exists and the DE tappers off according to Eq. 2 to a floor set by the bulk reflection. In some applications, a more aggressive taper and lower floor is desirable.

### Reflection Mode Composite Lens

In a composite configuration, a complementary pair of input and output reflection mode VHOEs is configured to diffract light into an N^{th} order where Nis not zero. The input and output VHOEs are positioned in parallel to and offset from each other such that the filtered N^{th} order beam exits the composite lens on a path at the angle of incidence and parallel to the broadband light while the unwanted 0^{th} order beam is discarded at each VHOE. Processing light in a non-zero diffraction order improves the suppression of unwanted wavelengths by increasing the taper and lowering the floor according to Eq. 2. Furthermore, processing the light through both input and output VHOEs serves to narrow the transmission bandwidth of the composite lens by successive applications of Eq 2. The successive application of Eq. 2 in the composite lens narrows the spectral FWHM (Eq. 3) and further suppresses the signal intensity in wavelengths outside of the region of interest. But processing light in a non-zero diffraction order induces angular dispersion according to Eq. 2. The output VHOE compensates for the induced angular dispersion under certain precise conditions. The composite lens improves suppression of unwanted wavelengths while still achieving minimal chromatic aberration. The composite lens may be configured as a filter only or a bi-convex or plano-convex lens equivalent.

The spectral FWHM of the output signal experiences equation 3 twice effectively multiplying the sin² function by itself.—[one example is the diffraction efficiency in Eq 2 is 1.0 at the desired wavelength, 0.5 at wavelengths 1 nm to either side of the desired wavelengths, and 0.1 at wavelengths 2 nm on either side of the desired wavelength. The FWHM of this system would be 2 nm. Two applications of this equation would yield a diffraction efficiency of 1.0 at the desired wavelength, 0.25 at wavelengths one nanometer on either side of the desired wavelength, and 0.01 at 2 nm on either side of the desired wavelength. The spectral FWHM would be less than 2 nm after 2^{nd} lens and the background signal would be reduced from 0.1 to 0.01. The exact shape and reduction in FWHM would depend on the design of the VHOE.

The input VHOE and output VHOE are fabricated as a complementary pair in which because the angles of the object and reference beam and exchanged between the two VHOEs. If the two VHOE are fabricated with the same thickness and refractive index modulation and placed parallel to each other, this configuration ensures that the angular and spectral dispersion (Eq 2) imparted to the beam exiting the input VHOE is compensated by the output VHOE. The spectral and angular compensation occurs because the θ and φ angles in Eq 1 are define by orientation of the reference and object beam. In the composite lens configuration, the beam exists the input VHOE as the object beam but enters the output VHOE as the reference beam this changes the sign of the angle and reverses the direction of the angular and spectral dispersion since the sin function in Eq 1 is an odd function sin θ=−θ.

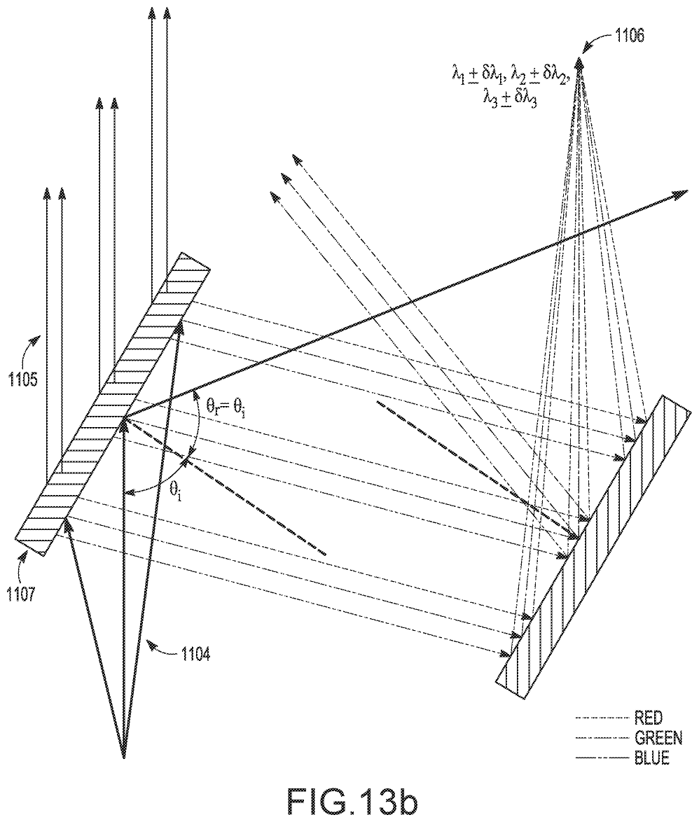

Referring now to FIG. 12, a “single wavelength” composite lens 898 includes a pair of reflective mode VHOEs, input VHOE1 901 and output VHOE2 903 that are arranged in parallel and offset from each other. Each VHOE includes a single diffraction grating recorded on a recording media. The diffraction grating is recorded to reflect incident light at a particular center wavelength and narrow bandwidth (e.g. 10-30 nm) and transmit other wavelengths to form a beam with a principal ray at a diffraction angle different than an angle of incidence 0^{th} diffraction order)) of the broadband light. The two VHOEs are fabricated as a complementary pair allowing for the possibility of optical power in none, one or both as will be discussed below. The diffraction may, for example, correspond to the ^{st} diffraction order. Each VHOE is suitably configured to exhibit a diffraction efficiency (DE) of >75% over the narrowband width in the 1^{st} diffraction order and to suppress light in the 0^{th} (and other) diffraction order to <1%.

Light 900 with a central wavelength λ and a bandwidth Δλ, where is Δλ<<λ, (e.g., <<means less than 10×) is incident on input VHOE1 901 at an angle of incidence angle θᵢ 907 relative to the surface normal. Input VHOE1 diffracts the incoming light 900 at a diffraction angle θ_{d} 911 that is different from the angle of incidence θᵣ=θᵢ 908 that would be reflected via Snell's law. The diffracted light 910 is diffracted in a range of angles θ_{d}±Δθ according to Equation 2 and 4. The diffracted light 910 travels to output VHOE2 903 that is aligned parallel to and offset from input VHOE1 901. The principal ray of diffracted light 910 is incident at a diffraction angle θ_{d} 904 and is diffracted at angle θᵢ 909 as light 905 which is parallel to the original light ray 900 and not along the path θᵣ=θ_{d}. Light 902 is also reflected from input VHOE1 according to Snell's law along the path θᵣ=θ_{d}. The input and output VHOEs are arranged such that light 902 bypasses output VHOE2 903. Similarly light 906 is reflected from output VHOE according to Snell's law along the path θᵣ=θ_{d} along a different path than light 905. The output VHOE introduces the same magnitude angular dispersion but of the opposite direction than the input VHOE to exactly compensate for and cancel the angular dispersion introduced by the input VHOE such that the light 905 diffracted from both VHOEs has minimal axial chromatic aberration.

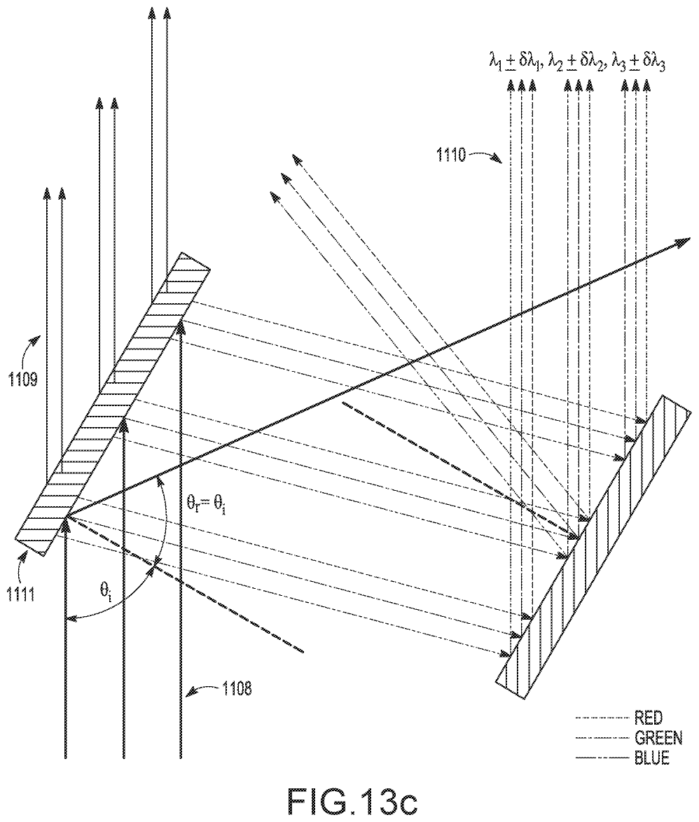

Three different configurations of “multiple wavelength” or “color” composite lenses are illustrated in FIGS. 13a through 13c including a plano-convex lens equivalent, a bi-convex lens equivalent and an optical filter. Each has the same configuration of the parallel and offset input and output VHOE as the single-wavelength lens. Each VHOE is recorded with plurality of diffraction gratings that diffract light at a plurality of center wavelengths and non-overlapping bandwidths. For example a VHOE may diffract light in narrow bandwidths e.g., 10-30 nm, centered at the wavelengths for red, green and blue. The difference in the three configurations being that the composite lens that is a planoconvex lens equivalent includes optical power in the output VHOE that focuses the parallel broadband light to an achromatic focus, the composite lens that is a biconvex lens equivalent includes optical power in both the input and output VHOEs (not necessarily the same) that focuses diverging broadband light to an achromatic focus, and the composite lens that provides only a filtering function includes no optical power in either VHOE.

Referring now to FIG. 13a, a “multi-wavelength” or “color” composite lens 998 that is a plano-convex lens equivalent includes a pair of reflective mode VHOEs, input VHOE1 1001 and output VHOE2 1007 that are arranged in parallel and offset from each other. Each VHOE includes multiple diffraction gratings recorded on a recording media. Each diffraction grating is recorded to reflect incident light at a particular center wavelength (e.g., R, G and B wavelengths) and narrow bandwidth (e.g. 10-30 nm) and transmit other wavelengths to form a beam with a principal ray at a diffraction angle different than an angle of incidence (e.g. 0^{th} diffraction order). A grating spacing parameter is varied across the diffraction gratings such that the center wavelengths all diffract at a common angle. The two VHOEs are fabricated as a complementary pair allowing for the possibility of optical power in none, one or both as will be discussed below. The diffraction angle may, for example, correspond to the 1^{st} diffraction order. Each VHOE is suitably configured to exhibit a diffraction efficiency (DE) of >75% over the narrowband width in the 1^{st} diffraction order and to suppress light in the 0^{th} (and other) diffraction order to DE <1%.

Parallel broadband light 1000 with a center wavelength λ and a bandwidth where Δλ is comparable (about 2×) to λ, is incident on input VHOE1 1001 at an angle of incidence θᵢ 1002 relative to a surface normal 1009. Input VHOE1 1001 is composed of multiple diffraction gratings, each of the multiple diffraction gratings diffracting a narrow band of wavelengths around a center wavelength and passing the other unwanted wavelengths 1004. VHOE1 1001 diffracts the incident light 1000 into diffracted light 1006 at a diffraction angle θ_{d} 1012 that is different from the θᵣ=θᵢ 1013 that would be reflected via Snell's law. The grating spacing parameter is varied among the multiple diffraction gratings so that they all diffract the principal ray at a common diffraction angle. The principal ray 1005 reflected at θᵣ=θᵢ 1013 bypasses the output VHOE2. The diffracted light 1006 at λ₁±δλ₁, λ₂±δλ₂, λ₃±δλ₃ from each of the multiple gratings in VHOE1 1001 is diffracted in a range of angles θ₁±δθ₁, θ₂±δθ₂, θ₃±δθ₃ according to Equations 2 and 4. The diffracted light 1006 travels to output VHOE2 1007 that is aligned parallel to the input VHOE. Some of the incoming light 1006 is reflected into light 1008 at angle θ_{d} 1012 relative to surface normal 1010 and exits the composite lens. The output VHOE2 exactly compensates for the angular dispersion introduced by the input VHOE1. The output VHOE also contains optical power and the multiple wavelengths diffracted from VHOE2 into beam 1014 are all focused to the same focal point (achromatic focus) 1011. This configuration is equivalent to a plano convex refracting lens but provides an achromatic focus free of axial chromatic aberration.

FIG. 13b shows a non-limiting case of diverging light 1104 entering the reflection composite lens and being focused to an achromatic focus 1106. The unwanted wavelengths 1105 pass through input VHOE1 1107. This configuration is equivalent to a bi-convex refracting lens but provides an achromatic focus free of axial chromatic aberration. The focal distances of the optical power in input VHOE1 and output VHOE2 do not have to be equal,

FIG. 13c shows a non-limiting case of parallel light 1108 entering the reflection composite lens and exiting as a parallel beam 1110 along a parallel path. The unwanted wavelengths 1109 pass through VHOE1 1110. The output light 1110 is filtered by the composite lens system.

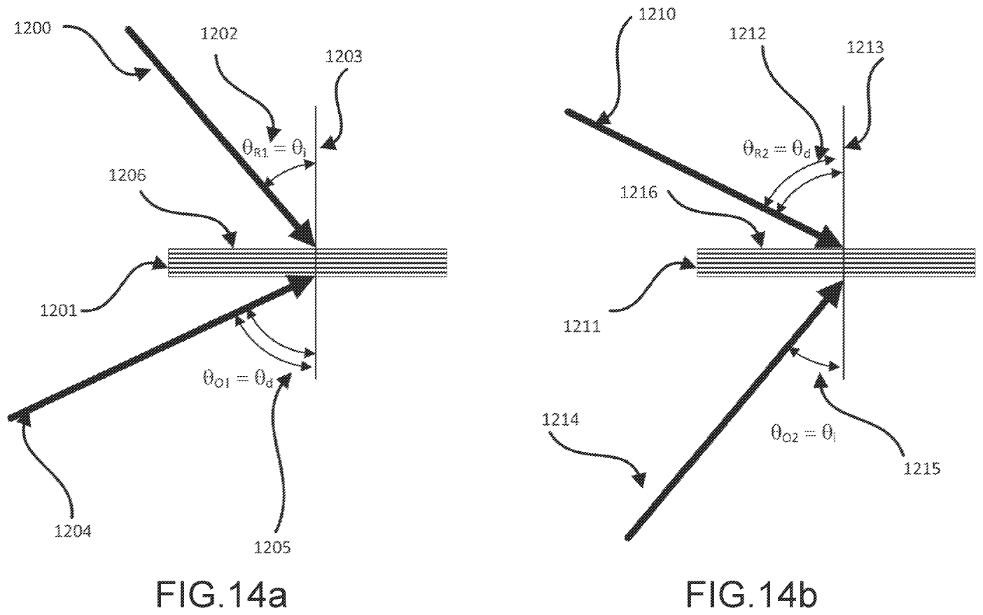

FIGS. 14a and 14b illustrate embodiments for fabricating the input VHOE and output VHOE, respectively. FIG. 14a illustrates a non-limiting example of the recording of a single wavelength input VHOE. The parallel reference light 1200 enters the recording media 1201 of a fixed thickness at an angle θ_{R1} 1202 to the surface normal 1203 equal to the designed angle of incidence θᵢ of the composite lens. From the opposite side of the recording media 1201, the primary ray of the object beam 1204 enters at an angle θ_{O1} 1205 to the surface normal 1203 equal to the designed internal diffraction angle of the composite lens (θ_{d}). The interference of the two beams generates fringes 1206 that are predominately parallel to the surface of the recording media with a fixed change in refractive index Δn. Object beam 1204 may in some embodiments contain optical power.

FIG. 14b illustrates a non-limiting example of the recording of a single wavelength output VHOE. The parallel reference light 1210 enters the recording media 1211 of the same thickness as the input VHOE at an angle θ_{R2} 1212 to the surface normal 1213 equal to the designed angle of incidence θ_{d} of the composite lens. From the opposite side of the recording media 1211, the primary ray of the object beam 1214 enters at an angle θ_{O2} 1215 to the surface normal 1213 equal to the incidence angle of the composite lens (θᵢ). The interference of the two beams generates fringes 1216 that are predominately parallel to the surface of the recording media with a fixed change in refractive index Δn. Object beam 1214 may in some embodiments contain optical power.

See-Through System with Reflective VHOE

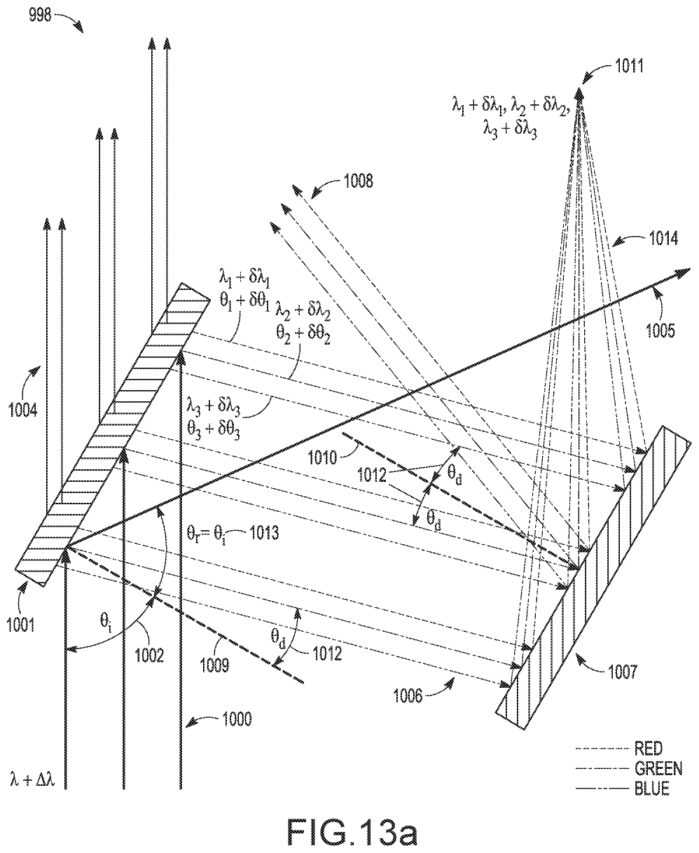

As shown in FIG. 11, the see-through feature of a reflective VHOE 200 allows for the configuration of an optical system in which an image of an object 201 can be superimposed on a real scene 202 to present a virtual image 204 to an observer 206, The reflective VHOE 200 is configured with one or more diffraction gratings at different wavelengths tuned to the wavelengths emitted by object 201. Light from the object 201 is reflected from the VHOE 200 to the observer. Light at wavelengths outside the bandwidths centered about these wavelengths from real scene 202 passes through VHOE 200 to the observer.

The embodiment of the reflection VHOE capability to simultaneously provide both a see through capability for a broad spectrum of light as well as optical magnification from a second source for one or more narrow band wavelengths each with a separate bandwidth enables the development of low cost, light weight and low profile optical elements that can create optical systems that are not achievable with traditional refractive or reflection optics.

A particular embodiment that shows the advantages of the reflective VHOE 200 would be the ability to construct a simple optical system inside a car allowing the driver to see the content of his smartphone or other display (i.e. object 201) without having to adjust their focus from the far field (i.e. real scene 202).

In this example, the reflective VHOE is designed to take a diverging beam from a cell phone or other image source and project a magnified image of one or more colors with bandwidths to the far field of the driver's view. The transparent reflective VHOE 200 is attached to windshield or visor of a vehicle. An image source 201 projects a diverging image toward the reflective lens at a distance di. The reflective VHOE combines an enlarged image of driver's phone placed on dashboard with the scene of the road in front of the vehicle. One example would be the projection of a mobile phone image in such a way that driver would not have to shift his sight from the road nor refocus his eyes to see the phone content.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. A reflection mode lens, comprising:
an input reflection mode volume holographic optical elements (VHOE) configured to accept broadband light at an angle of incidence and diffract the light at one or more center wavelengths and non-overlapping bandwidths and transmit other wavelengths to form a first beam from the diffracted light with a principal ray at an Nth order diffraction angle where N is not zero and where the diffraction angle is not equal to the angle of incidence; and
an output reflection mode VHOE positioned parallel to the input reflection mode VHOE such the first beam is incident at the Nth order diffraction angle and diffracted to form an output beam with a principal ray at the angle of incidence and parallel to the broadband light,
wherein the output reflection mode VHOE compensates for angular dispersion introduced by the input reflection mode VHOE.

2. The reflection mode lens of claim 1, wherein the input reflection mode VHOE was recorded with a reference beam at the angle of incidence and an object beam at the Nth order diffraction angle and the output reflection mode VHOE was recorded with a reference beam at the Nth order diffraction angle and an object beam at the angle of incidence.

3. The reflection mode lens of claim 1, wherein said input reflection mode VHOE and said output reflection mode VHOE are offset from each other such that an unwanted beam reflected from the input reflection mode VHOE at the angle of incidence bypasses the output reflection mode VHOE.

4. The reflection mode lens of claim 3, wherein an unwanted beam reflected from the output reflection mode VHOE travels along a different path than the output beam.

5. The reflection mode lens of claim 1, wherein the broadband light enters the lens as parallel light, is filtered into the one or more wavelengths and non-overlapping bandwidths, and exits as parallel light in the output beam along a parallel path.

6. The reflection mode lens of claim 1, wherein the output reflection mode VHOE has optical power, wherein the broadband light enters the lens as parallel light, is filtered into the one or more wavelengths and non-overlapping bandwidths and focused to an achromatic focus.

7. The reflection mode lens of claim 1, wherein the input and output reflection mode VHOEs have optical power, wherein the broadband light enters the lens as diverging light of a first focal distance, is filtered into the one or more wavelengths and non-overlapping bandwidths and focused to an achromatic focus of a second focal distance.

8. The reflection mode lens of claim 7, wherein each of the input and output VHOEs are configured to diffract light at an Nth order diffraction angle where N is not equal to zero such that each VHOE exhibits diffraction efficiency (DE) of >75% over each of the bandwidths in the Nth diffraction order and suppresses light in the 0^{th} diffraction order such that its DE in the 0^{th} diffraction order is <1%.

9. The reflection mode lens of claim 1, wherein the input and output reflection mode VHOEs each comprise a single diffraction grating configured to diffract light at a single center wavelength and bandwidth.

10. The reflection mode lens of claim 1, wherein the input and output reflection mode VHOEs each comprise like a plurality of diffraction gratings that each diffract light at one of the plurality of center wavelengths and non-overlapping bandwidths, wherein a grating period varies among the plurality of diffraction gratings such that the different wavelengths are all diffracted at a common angle.

11. The reflection mode lens of claim 1, wherein the input reflection mode VHOE introduces angular dispersion about the principal ray in the first beam, wherein the output reflection mode VHOE introduces the same magnitude angular dispersion but of the opposite direction to compensate for and cancel the angular dispersion introduced by the input reflection mode VHOE such that the output beam has minimal angular axial chromatic aberration.

12. A reflection mode lens, comprising:
an input reflection mode volume holographic optical elements (VHOE) configured to accept broadband light at an angle of incidence and diffract the light at one or more center wavelengths and non-overlapping bandwidths and transmit other wavelengths to form a first reflected beam at the angle of incidence and a first diffracted beam at an Nth order diffraction angle where N is not zero and where the diffraction angle is not equal to the angle of incidence; and
an output reflection mode VHOE positioned parallel to and offset from the input reflection mode VHOE such the first reflected beam bypasses the output reflection mode VHOE and the first diffracted beam is incident at the Nth order diffraction angle where the light is diffracted to form a second diffracted beam that travels a path at the angle of incidence and parallel the broadband light, and a second reflected beam that travels a different path;
wherein the input reflection mode VHOE induces angular dispersion in the first diffracted beam
wherein the output reflection mode VHOE introduces the same magnitude angular dispersion but of the opposite direction to compensate for and cancel the angular dispersion introduced by the input reflection mode VHOE such that the second diffracted beam has minimal axial chromatic aberration.

13. The reflection mode lens of claim 12, wherein each of the input and output reflection mode VHOEs comprise a recording media and a diffraction pattern recorded on said recording media with fringes of the diffraction pattern substantially parallel to a top surface of the recording media, wherein the diffraction pattern is configured with a grating period to diffract light at the Nth order diffraction angle.

14. A reflection mode lens, comprising:
a reflection mode volume holographic optical element (VHOE) comprising a recording media and a diffraction pattern recorded on said recording media with fringes of the diffraction pattern substantially parallel to a top surface of the recording media, said diffraction pattern configured to accept broadband light at an angle of incidence and reflect light achromatically at a center wavelength and bandwidth and transmit other wavelengths to form an output beam fro m the reflected light with a principal ray at an angle equal to an angle of incidence of the broadband light and to magnify through diffraction the output beam to form an image.

15. The reflection mode lens of claim 14, wherein a hologram that records the diffraction pattern includes a primary component in which the fringes are parallel to the top surface to provide achromatic reflection over the bandwidth and a secondary component in which the fringes have a measure of curvature to the top surface to provide optical power to magnify the output beam, the amount of deviation of the fringes from parallel determined by an f-number of the lens.

16. The reflection mode lens of claim 14, wherein said VHOE is recorded with a collimated reference beam and a non-collimated object beam at the known wavelength at equal but opposite angles with respect to a surface normal of the recording media on opposite sides of the recording media to record the diffraction pattern, wherein the equal but opposite angles are equal to the angle of incidence of broadband light.

17. The reflection mode lens of claim 14, wherein said diffraction pattern comprises a plurality of diffraction gratings configured with different grating periods to deflect through reflection light at a plurality of different center wavelengths and non-overlapping bandwidths at a common angle to bring all of the reflected light to a common focus to form the image.

18. A method of fabricating a reflection mode lens, comprising:
interfering a collimated reference beam and a non-collimated object beam configured with optical power at equal but opposite angles, equal to an angle of incidence of broadband light, with respect to a surface normal of a recording media on opposite sides of the recording media to record a diffraction pattern on the recording media with fringes of the diffraction pattern substantially parallel to a top surface of the recording media to form a reflection mode VHOE, said diffraction pattern configured to reflect light achromatically at a known wavelength and bandwidth and transmit other wavelengths to form an output beam from the reflected light with a principal ray at an angle equal to the angle of incidence of broadband light and to magnify through diffraction the output beam to form an image.

19. A method of fabricating a reflection mode composite lens for receiving broadband light at an angle of incidence, comprising:
interfering a collimated reference beam and an object beam at angles with respect to a surface normal of a recording media equal to the angle of incidence and an Nth order diffraction angle, respectively, on opposite sides of the recording media to record a diffraction pattern on the recording media with fringes of the diffraction pattern substantially parallel to a top surface of the recording media to form an input reflection mode VHOE, said diffraction pattern configured to accept broadband light at the angle of incidence and diffract light at a center wavelength and bandwidth and transmit other wavelengths to form a first beam from the diffracted light with a principal ray at the Nth order diffraction angle where N is not zero and where the Nth order diffraction angle is not equal to the angle of incidence of broadband light; and
interfering a collimated reference beam and an object beam at angles with respect to a surface normal of a recording media equal to the Nth order diffraction angle and the angle of incidence, respectively, on opposite sides of the recording media to record a diffraction pattern on the recording media with fringes of the diffraction pattern substantially parallel to a top surface of the recording media to form an output reflection mode VHOE, said diffraction pattern configured to accept the first beam from the input reflection mode VHOE at the Nth order diffraction angle and diffract light at the center wavelength and bandwidth to form an output beam from the diffracted light with a principal ray at the angle of incidence of the broadband light.

20. The method of claim 19, wherein said diffraction pattern for each of the input and output reflection mode VHOEs comprises a plurality of diffraction gratings configured with different grating periods to deflect through reflection light at a plurality of different center wavelengths and non-overlapping bandwidths at a common angle to bring all of the reflected light to a common focus to form the image.
